(19) United States
(12) Patent Application Publication
(10) Pub. No.: US 2017/0024796 A1
(43) Pub. Date: Jan. 26, 2017

(54) SYSTEMS AND PROCESSES FOR SIZING APPAREL ITEMS FROM A PLURALITY OF PRODUCT OFFERINGS

(71) Applicant: Jessica Fabo, Johnstown, PA (US)

(72) Inventor: Jessica Fabo, Johnstown, PA (US)

(21) Appl. No.: 14/807,845

(22) Filed: Jul. 23, 2015

(51) Int. Cl. G06Q 30/06

(52) U.S. Cl. CPC G06Q 30/0631

(57) ABSTRACT

This invention details systems and processes for sizing apparel items from a plurality of product offerings

### CROSS-REFERENCE TO RELATED APPLICATION

This application claims priority under 35 USC 119 to U.S. Provisional Application Number 62/028,790 filed Jul. 24, 2014; incorporation herein in its entirety.

### FIELD OF THE INVENTION

The invention is directed to systems and processes for sizing apparel items from a plurality of product offerings.

### BACKGROUND OF THE INVENTION

The success of the internet has influenced significantly the development and progress of e-commerce. The Internet allows purchasers to access products at bargain prices. Retailers and vendors can also acquire a better understanding of the markets by analyzing pricing schemes of competitors, and purchasing habits of consumers.

Purchasers can buy a wide variety of products online, but the purchase of such products is usually limited to products where dimensions or size are not critical to customer satisfaction. Therefore, purchase of items where a good fit is critical is frequently not made on the Internet, but instead in brick and mortar stores where the item can be visually or otherwise directly inspected to ensure a good fit. When such purchases are made on the internet, and the product does not fit the customer, it is often returned at a cost to the vendor, resulting in reduced revenue, and sometimes, in price increases to the consumer. Therefore, there remains a need for a system which can accurately recommend the size of a product to be purchased on-line, e.g. on the internet, based on information that the purchaser can easily provide. This system could also be used when purchasing at a brick-and-mortar store; offline purchase.

Currently, applications exist which use scanners but are generally inaccurate. In the existing applications, users have obtained a resultant item after being scanned that should “in principle” fit based on the “scan” of a user's body. However, currently available scanners are basically an educated guess and limited to a general size, e.g. small, medium or large based on a specific size range in most items. Although digitally-constructed images of clothing draped on a 3D mannequin representing a user's body are impressive in presentation, they do not provide actual further confirmations from those with the same size, shape and lit preferences. 3D modeling, such as provided by Cad Modeling Ergonomics s.r.l. (Italy), address the various shapes and sizes of users in their mannequin products.

There still exists today the need for systems and methods for users to provide specific information to obtain well fitting clothes in style, design and cost while appreciating how and where to obtain the apparel. More particularly, a website that recognizes “size groups” that can “learn” from a central “social comment” or “size leader”; numerous users of the same sizes can find out what does, or does not, fit well from the information gathered by one particular spokesperson of the same size group based on collective comments.

### BRIEF SUMMARY OF THE INVENTION

In a first embodiment, the invention is directed to a process for sizing apparel items from a plurality of product offerings, the process including (i) inputting actual measurements and fit preferences of a user into a Request Database to create a User Profile; and thereafter (ii) submitting a Product Request based on the User Profile from the Request Database to an electronically implemented Computational Analysis System (CAS) to determine a preferred fit for a user. The CAS disseminates items and information from a Retailer Database (RD) and a Collective Collaboration Knowledge Database (CCKD) from users' experiences of the preferred fit items to fulfill the Product Request based on a User Profile submitted from the Request Database. The RD includes apparel item details for a plurality of brands available at retailers, including but not limited to, brand name, brand line, pricing, apparel item dimensions, and apparel item color. Potentially apparel item popularity based on reviews, location of the apparel item, and apparel item ratings can be included. The CCKD accesses social comments regarding apparel, including but not limited to, apparel listed within the Retailer Database and User Profiles obtained from numerous users, of the same or similar size. The final step is to identify one or more apparel items of interest based on the preferred fit.

In another embodiment, the invention is directed to a system for sizing apparel items from a plurality of product offerings, the system including (i) a Request Database for inputting actual measurements and fit preferences of a user to create a User Profile and submitting a Product Request from a user for specific desired items for purchase. The system further includes a Retailer Database (RD) for inputting apparel item details from a plurality of brand manufacturers and/or retailers. The apparel item details in the RD include at least one of, but are not limited to, categorical apparel item type, brand name, brand line, pricing, apparel item dimensions, apparel item color, potential apparel item popularity based on reviews, location of the apparel item, and apparel item ratings. A Computational Analysis System connected to both the Request Database and the Retailer Database receives the Product Request and determines a preferred fit for a user, wherein the preferred fit is based on 1) the dissemination of items and information from the User Profile in the Retailer Database and the Request Database and 2) the Collective Collaboration Knowledge Database (CCKD), a public database from users' experiences of the preferred fit items.

In yet another embodiment, the invention is directed to a business method for the marketing and sales of apparel items from a plurality of product offerings, the process including (i) implementing business collaboration for acquiring information regarding apparel item details for a plurality of brand manufacturers and/or retailers, the apparel item details including at least one of categorical apparel item type, brand name, brand line, pricing, apparel item dimensions, apparel item color, potential apparel item popularity based on reviews, location of the apparel item, and apparel item ratings; (ii) establishing a system for sizing apparel items from a plurality of product offerings; (in) providing a discount procedure for apparel items purchased via the business method; providing marketing opportunities via the system to the brand manufactures and/or retailers; and (iv) updating the information, discounts and marketing opportunities on the system on a continuous basis.

### BRIEF DESCRIPTION OF THE DRAWINGS

FIG. 1 is a plan view of the system of the present invention.

### DETAILED DESCRIPTION OF THE INVENTION

Certain terminology is used herein for convenience only and is not to be taken as a limitation on the present invention. The terminology includes the words specifically mentioned, derivatives thereof and words of similar import. The embodiments discussed herein are not intended to be exhaustive or to limit the invention to the precise form disclosed. These embodiments are chosen and described to best explain the principle of the invention and its application and practical use and to enable others skilled in the art to best utilize the invention.

In a first embodiment, the invention is directed to a process for sizing apparel items from a plurality of product offerings, the process including (i) inputting actual measurements and fit preferences of a user into a Request Database to create a User Profile. The User Profile allows users to do various searches, using the various pluralities of categorical item type; color, style, etc., such as 1) to find items that other people in their “Size Group” recommend, 2) to find items that retailers feel would fit adequately based on their given measurements, and 3) to find other User Profiles to “browse” their closets for clothing ideas.

Thereafter, (ii) submitting a Product Request based on the User Profile from the Request Database to an electronically implemented computational analysis system (CAS) to determine a preferred fit for a user for a shopping request from a user. The CAS disseminates items and information from a Retailer Database (RD) and a Collective Collaboration Knowledge Database (CCKD) from user experiences of the preferred fit items to fulfill the Product Request based on a User Profile submitted from the Request Database. The RD includes apparel item details for a plurality of brand manufacturers, retailers, and apparel item details. The RD includes at least one of categorical apparel item type, brand name, brand line, pricing, apparel item dimensions, apparel item color, potential apparel item popularity based on reviews, location of the apparel item, and apparel item ratings. The CCKD accesses user preferences and social comments obtained from numerous users of the same, or similar, size regarding apparel, including but not limited to the apparel in the Retailer Database. The final step is to (iii) identify one or more apparel items of interest based on the preferred fit.

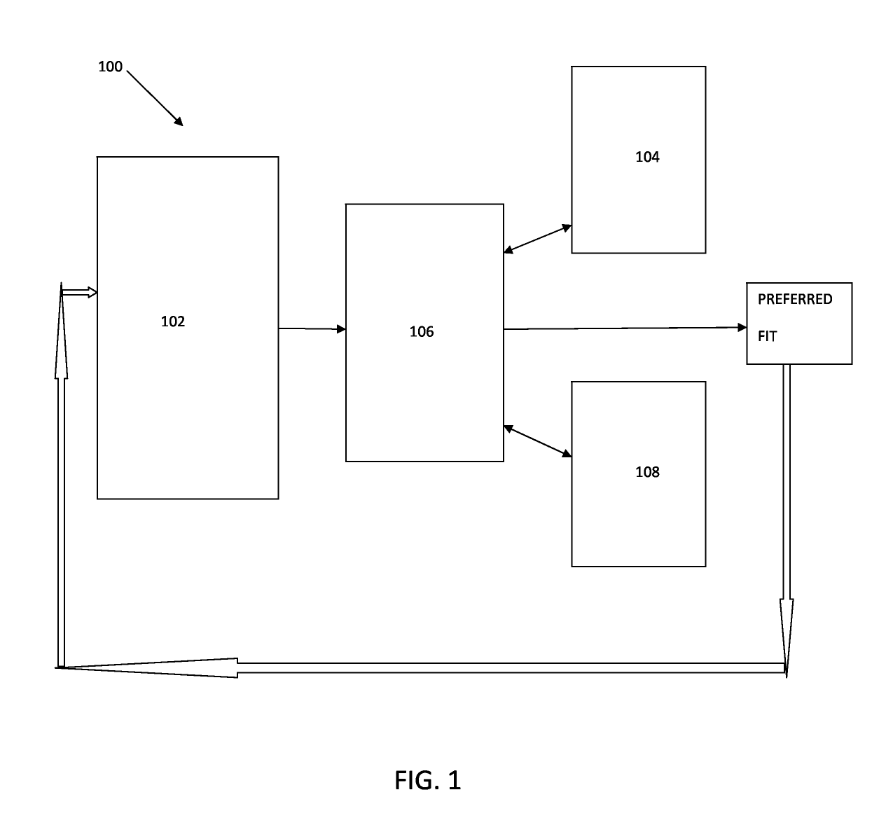

Once the apparel items are “identified” by the user based on the method, the user may “re-submit” the request with additional detail based on the information received from the Retail Database and CCKD social media information. Thus, the system is self-propagating until the most exact “match” is found as best illustrated in FIG. 1.

In the present embodiment, the process is initiated via a website, which can be in mobile application form (“app”), which takes the information from professionally obtained bodily measurements and creates the User Profile as a “software package” for each user so that individual users can easily find which clothing brands and styles optimally fit their measurements. Further, the User Profile, within the software package can be accessed via the website (with access permission) for use by others who desire an individual's User Profile to, for example, purchase gifts etc. The software package includes, for example, GKS Services Corp. product called “Geodesic Distance Measurement” which takes the measurements directly off the scan data: CAD though not required would potentially be acceptable as would 3D scanners. Users would also enter their “likes” and “dislikes” as part of their User Profile for various brands and styles based on trial and error fittings and (potentially) rate them accordingly for “true to life” fits and opinions. As provided in the present invention, the more information gathered, the better the accuracy of the shopper profile and request.

The information in the software package along with personal shopping preferences, such as how you prefer the fit of your clothes, would be input into Request Database and your User Profile would automatically be created. It should be recognized that if someone feels “squeamish” about getting scanned, their information could be put into the system by a professional tailor. The software package, whether on an “app” on a mobile device or on a computer hard drive, would keep a record of the ideal sizes and styles “at-a-glance” to increase efficiency when shopping, and in addition, offer suggestions for different brands that would also fit. Commonly, there would be 3 different measurements for each user, if they choose to take advantage of multiple measurements, because weights and sizes do fluctuate according to the time of year and life activity. The user would shop according to the range you fall into at that time and would make adjustments accordingly. This “fluctuation” would be recognized by the RD and be reflected, e.g. in materials of the apparel.

The User Profiles created, in addition to the matched or purchased apparel selected, could be accessed by stores for gift-giving purposes or willingly shared with others for the same reason (gifts and practicality). This information could be used as an additional source of revenue much like a “customer list” for targeted marketing. Additionally, banner ads could be included on the website as a revenue generator for the system/process of the present invention to support the business method. These ads can be potentially selected based on the User Profile and Product Request from a designated IP address.

Referring to FIG. 1, in another embodiment, the invention is directed to a system 100 for sizing apparel items from a plurality of product offerings, the process including a Request Database 102 for inputting actual measurements and fit preferences of a user to create a User Profile. As discussed, existing basic scanner technology will recognize a small or medium size, or a defined size, e.g. 4 or 6, in most items which is known before having stepped into a scanner. Therefore, current scanners known in art do not tell the user anything new nor do they give more shopping confidence because other people who are the same size have “vetted” it. In the present invention, in addition to commercially available scanning devices, specialized scanning software has been developed to augment the “details” obtain by scanning and therefore, provide the ability to obtain optimally fitting apparel for a user.

As discussed in the previous embodiment, the software package in the Request Database takes the measurements directly off the scan data; CAD is acceptable but specialized software is created which would provide an efficient interrelationship between the database discussed herein.

The system 100 further includes a Retailer Database 104 for inputting apparel item details for a plurality of brand manufacturers and/or retailers. The apparel item details include at least one of categorical apparel item type, brand name, brand line, pricing, apparel item dimensions and apparel item color. Potentially, the Retail Database 104 can include apparel item popularity based on reviews, amount of sales and location of the apparel item. The Retailer Database 104 would be established in conjunction with commercial retailers. These commercial retailers would potentially include well known companies such as Macy's, Lord and Taylor etc., in addition to boutiques which may have only one or two physical stores or online retailers that have no physical stores; they would, be no geographical limits. These retailers would continuously update and revise their offerings to provide a “match” to the Product Request. As would be appreciated, the Retailer Database 104 would be continually updated with more items, including how many items are in stock in each store, new designs, and seasonal apparel; as routinely performed for changes in stock, seasonal changes, new styles, etc. A list of stores, brands, and styles would be available for a user to access clothing in your size range via your profile page. When shopping and “try things on” you would establish (using the User Profile to track preferences) whether or not something that claims it should fit the users' size, actually does or does not. This information would update the results in a “collective collaboration” manner, which would improve the system over time.

A Computational Analysis System (CAS) 106 which has accesses to both the Request Database 102 and Retailer Database 104, receives the Product Request to determine a preferred fit for a user for the shopping request, wherein the preferred fit is based on 1) the dissemination of items and information from the User Profile in the Request Database and 2) information in the Retailer Database 104 and a Collective Collaboration Knowledge Database (CCKD) 108, also accessible by the CAS 106, stored in a public database from users experiences of the preferred fit items.

In a preferred embodiment, the CAS software disseminates the information based on hierarchy of search “terms” which “finds” the resultant apparel from the information in the User Profile (Request Database), Retailer Database and “comment” from the CCKD. Thus, as more information is put into the system, e.g. comment, fit preferences etc., these additional search terms “self propagate” the search to find a more “exact match” for the user. Further, the CAS 106 creates specific “size group” information such that is encoded in the User Profile's information.

The User Profile created by the present invention appreciates whether or not a person prefers their clothing to fit a certain way; tight, normal, loose, or baggy etc. and is incorporated to obtain the preferred fit based on the User Profile in the Request Database 102. The User Profile is a personal inventory system and provides the user with the ability to keep track of their personal shopping store item preferences, e.g. the user may like jeans size 4R in mild flair from Macy's department store and rate them as 10 out of 10. Further, the user can provide their personal wear preferences, e.g. the user prefers jeans to not be tight in the calf [6/10] and knee [8/10]. It should be recognized that the User Profile exists on its own, whether or not the user does not choose to do anything more than to use it as a catalogue system for keeping track of their current preferences.

In contrast to existing technology, which limits options and thereafter you must further pinpoint your desired apparel, via “trial and error”; the present invention includes Collective Collaboration Knowledge Database (CCKD) 108. The CCKD 108 accesses social comment to obtain from numerous users of the same sizes comments regarding apparel, including but not limited to the apparel in the Retailer Database 104. The ability to have access to social media such as Face Book, allow comment on specific apparel items in regarding to “sizing”, quality etc. The User Profile's information is uniquely integral and a core link to the Collective Collaborative Knowledge Database, 108. The User Profile is accessible to the CCKD 108 and Retailer Database 104 via the CAS 106.

Further, based on the additional information provided, the resultant apparel “found” by the present invention could establish a rating system for each item based on personal preferences (For example, this shirt rates a 4 in longer arms and a 10 for shorter torso). This rating systems would be based on a defined list evaluation points achieved the more achieved the higher the rating. For example, a shirt which provided excess room in the shoulder would either be a desired property of the user (based on input) and therefore receive a higher rating or, if not desired by the user, receive a lower rating. Simply, for each characteristic of the item that “matches” the desired characteristics of the user, the rating would increase. However, the most basic concept is a clothing-related website based on actual measurements “matched” with retailer information and user endorsements.

In yet another embodiment the invention is directed to a business method for marketing and sales of apparel items from a plurality of product offerings, the method including (i) implementing business collaboration for acquiring information regarding apparel item details for a plurality of brand manufacturers and/or retailers. The apparel item details including at least one of categorical apparel item type, brand name, brand line, pricing, apparel item dimensions, apparel item color, potential apparel item popularity based on reviews, location of the apparel item, and apparel item ratings; (ii) establishing a system for sizing apparel items from a plurality of product offerings; (iii) providing a discount procedure for apparel items purchased via the business method; (iv) providing marketing opportunities via the system to the brand manufactures and/or retailers; and (v) updating the information, discounts and marketing opportunities on the system on a continuous basis.

The business method of the present invention will be a collaborative effort of the present invention, manufacturers/retailers and social comment to establish a recognized brand based on the central concept of the invention. A website that uses “size groups” that can learn from a central “size leader”; that numerous users of the same sizes can find out what does or does not fit well from the information gathered by one particular spokesperson of the same size group. Thus, the present invention provides a self-propagating method which, through a specific alignment of information (maintained on software) provides an effective and efficient tool for shopping while creating a marketing and sales opportunity supported by social media. Specifically, the marketing and sales opportunities based on the present invention could include, but are not limited to, 1) creation and sale of customer profiles for targeted marketing (as discussed); 2) advertisement of “new” apparel and related items on the web page or mobile app., and 3) the introduction of multiple service provides, manufactures and retailers for potential collaborations based on most popular items.

One skilled in the art will recognize the applicability of the present invention with social media. Specially, the present invention could be the basis of a Face book page for fashion/shopping that takes the guesswork and hassle out of the shopping experience and allows customers to confidently buy items online. Moreover, it is a website where the end users have an online profile in which your own size and style preferences are continually updated, but that it extremely specific.

### EXAMPLES

### Example 1

The completed “scans” input into a computer server-based database or they can be professionally measured by a tailor, most commonly, 25 measurements in which case a form would be used. As discussed, if measured by a professional tailor, the measurements would be recorded on a paper form and then the information would be added to the online database through an account that the tailors would have access to. For security, access would be limited to the user with authorization to the database, as the purpose is to maintain accurate measurements. The paper forms would eventually use iPads and would record and upload the information that way. Clothing manufacturers can also add their information (meaning what sizes their clothing is directed) using these forms, as well.

Manufacturers/brands/boutiques give their sizing information by requesting it and by them understanding that they would get exposure/advertising because the “matches” would be displayed through a search on an individual's profile. For example, if a “G” body type in a medium size is looking for blue shirts, clothing that would be a 75-100% accurate match based on actual measurements, personal fit criteria, and similar users reviews, would be displayed “first”, and “matches”, “further down” on the accuracy scale, e.g. of less accuracy, would be listed lower on the “match list”. This list would include where to buy, the price, a picture, and a link to purchase the item (whenever possible). Further, there would also be tracking of how many pieces of clothing are at each store based on stock numbers or stock software as used in the industry.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for sizing apparel items from a plurality of product offerings, the process comprising:
(i) inputting actual measurements and fit preferences of a user into an Request Database to create a User Profile:
(ii) submitting a Product Request based on the User Profile from the Request Database to an electronically implemented computational analysis system (CA) to determine a preferred fit, wherein the CA system disseminates items and information from a Retailer Database and a Collective Collaboration Knowledge Database (CCKD) from users experiences of the preferred fit items to fulfill the shopping request based on a Product Request submitted from the Request Database, wherein the Retailer Database comprises apparel item details for a plurality of brand manufacturers and/or retailers, the apparel item details comprising at least one of categorical apparel item type, brand name, brand line, pricing, apparel item dimensions, apparel item color, potential apparel item popularity based on reviews, location of the apparel item, and apparel item ratings; wherein the CCKD accesses social comment to obtain from numerous users of the same sizes comments regarding apparel, including but not limited to the apparel in the Retailer Database; and
(iii) identifying one or more apparel items of interest based on the preferred fit.

2. The process of claim 1 further comprising adding additional information and preferences to the preferred fit results and submitting the request with the additional information to the computational analysis system for a further specific preferred fit.

3. The process of claim 2, wherein the process can be implemented utilizing either a server or a desktop version.

4. The process of claim 3, wherein the results of the preferred fit are stored on a database for future shopping purchases.

5. The process of claim 4, wherein the search results additionally display at least one of the images of the apparel items of interest, price, and quality of match established using the closeness of fit score, size the customer has to purchase, ratings, name of the product, brand, and details of a store where the product is available.

6. The process of claim 6, wherein the customer can become authenticated on the system and any query made by the customer is then stored in a database, wherein once authenticated the queries of the customer are analyzed to obtain characteristics that allow for appropriate products to be suggested to the customer.

7. A system for sizing apparel items from a plurality of product offerings, the process comprising:
(i) a Request Database for inputting actual measurements and fit preferences of a user to create a User Profile;
(ii) a Retailer Database for inputting apparel item details for a plurality of brand manufacturers and/or retailers, the apparel item details comprising at least one of categorical apparel item type, brand name, brand line, pricing, apparel item dimensions, apparel item color, potential apparel item popularity based on reviews, location of the apparel item, and apparel item ratings;
(iii) an online computer device for submitting a Product request from a user for specific desired items for purchase; and
(iv) a Computational Analysis System connected to the Request Database, to receive the Product Request to determine a preferred fit for a user, wherein the preferred fit is based on 1) the dissemination of items and information from the User Profile in the Request Database and Retailer Database, and
(v) a Collective Collaboration Knowledge Database (CCKD) connected to a public database, wherein the CCKD comprises users experiences and comment of the preferred fit items, wherein the CCKD and the CAS are connected,
wherein the User Profile is accessible to the CCKD and Retailer Database via the CAS.

8. A business method for marketing and sales of apparel items from a plurality of product offerings, the process comprising:
(i) implementing business collaboration for acquiring information regarding apparel item details for a plurality of brand manufacturers and/or retailers, the apparel item details comprising at least one of categorical apparel item type, brand name, brand line, pricing, apparel item dimensions, apparel item color, potential apparel item popularity based on reviews, location of the apparel item, and apparel item ratings;
(ii) establishing the system of claim 8;
(iii) providing a discount procedure for apparel items purchased via the business method;
(iv) providing marketing opportunities via the system to the brand manufactures and/or retailers; and
(v) updating the information, discounts and marketing opportunities on the system on a continuous basis.
